(19) United States
(12) Patent Application Publication
(10) Pub. No.: US 2026/0155028 A1
(43) Pub. Date: Jun. 4, 2026

(54) MODULAR UNIT FOR A MODULAR SIGNALING COLUMN

(71) Applicant: Davide GARNERONE, Carpi (Modena) (IT)

(72) Inventor: Davide GARNERONE, Carpi (Modena) (IT)

(21) Appl. No.: 19/406,464

(22) Filed: Dec. 2, 2025

(30) Foreign Application Priority Data
Dec. 2, 2024 (IT) 102024000027171

(51) Int. Cl. G08B 7/06; G08B 3/10; G08B 5/36

(52) U.S. Cl. CPC G08B 7/06; G08B 3/10; G08B 5/36

(57) ABSTRACT

A modular unit for a modular signaling column has an outer element having an inner surface defining an inner space, a pair of apertures at axially opposite ends, a connection portion arranged adjacent to a first aperture of the pair of apertures and provided with first mechanical bayonet connections, and second mechanical bayonet connections arranged in the inner surface of the outer element suitable for cooperating with the first mechanical bayonet connections of an axially adjacent modular unit. The modular unit has an electrical connection plate having a plurality of arcuate or circular concentric contact tracks and a printed circuit board mountable in the inner space of the outer element. In a condition of mechanical bayonet coupling between two modular units the two modular units are electrically connected by sliding contact between a first connector of one modular unit and respective contact tracks of the other modular unit.

### CROSS-REFERENCE TO RELATED APPLICATION

This application claims priority to Italian Patent Application No. 102024000027171 filed Dec. 2, 2024, the contents of which is hereby incorporated in its entirety by reference.

### TECHNICAL FIELD

The present invention relates to the field of signal pillars, in particular luminous or acoustic-luminous signal pillars for installation in fixed positions in industrial environments.

### STATE OF THE ART

Acoustic-luminous beacons are essential devices for ensuring safety and efficiency in industrial environments. These devices combine light and/or sound signals to warn operators about various operating conditions, particularly critical or emergency situations. The acoustic-luminous beacons are designed to be installed on machinery, industrial equipment and other critical points, improving situational awareness and reducing the risk of accidents at work. Whether alerting operators to an emergency stop, signaling the completion of a production cycle or indicating a safety alert, these devices play a key role in keeping industrial environments safe and efficient.

They are known as light and sound-luminous beacons comprising a plurality of cylinder housings, manufactured as modular units that can be stacked and vertically coupled to form a column. The housings each comprise a tubular cylindrical wall at least partially transparent, within which are one or more LED elements of different colors, such as red, green, yellow and blue, each corresponding to a specific operating state or alarm condition. Columns may be single-phase, providing a single color of light, or multi-phase, with the ability to emit multiple colors in sequence or simultaneously. Bollards may also include built-in acoustic devices to provide audible alerts along with visual alerts.

Typically, light columns are installed at strategic points in industrial plants, such as production lines, machinery, loading/unloading areas and access points, to warn operators of critical situations, such as emergency stops, breakdowns, process completion or safety alarms. Because they are bright and can be viewed from different angles, they provide effective communication even in noisy environments or with limited visibility.

### SUMMARY OF THE INVENTION

It is an object of the present invention to realize a modular signal tower unit with an efficient connection and mounting system that allows a plurality of modular units to be mechanically and electrically associated simultaneously.

This and other purposes and advantages, which will be better understood below, are achieved, according to one aspect of the present invention, by a modular unit for a modular signal tower as described and claimed herein.

In summary, the modular unit comprises an outer element defining an inner space arranged to accommodate a printed circuit board arranged for electrical connection with an electrical connection plate. The modular unit further provides for bayonet connection means for associating several modular units mechanically wherein the mechanical bayonet connection results in an electrical connection between the modular units by means of sliding contact of connectors on the printed circuit board and concentric contact tracks on the electrical connection plate.

According to a further aspect, the present invention realizes a modular top unit for a modular signaling column.

According to a further aspect, the present invention realizes a modular control unit for a modular signaling column.

According to a further aspect, the present invention realizes a modular signaling column.

### BRIEF DESCRIPTION OF THE DRAWINGS

FIG. 1 is an exploded perspective view of components of a module of a modular signal pillar according to an embodiment of the present invention;

FIG. 2 is a perspective view of an electrical connection plate of a modular unit according to a form of embodiment of the present invention;

FIG. 3 is a perspective view of an outer element of a modular unit according to a form of embodiment of the present invention;

FIG. 4 is a further perspective view of an outer element of a modular unit according to an embodiment of the present invention;

FIG. 5 is a further perspective view of an outer element of a modular unit according to a form of embodiment of the present invention;

FIG. 6 is an exploded perspective view of components of a top modular unit according to a form of embodiment of the present invention; and

FIG. 7 is an exploded perspective view of components of a modular control unit according to an embodiment of the present invention.

### DETAILED DESCRIPTION

Various aspects and forms of embodiments of modular signal tower units have been described. It is understood that each form of embodiment can be combined with any other form of embodiment. Furthermore, the invention is not limited to the described forms of embodiment, but may be varied within the scope defined by the appended claims.

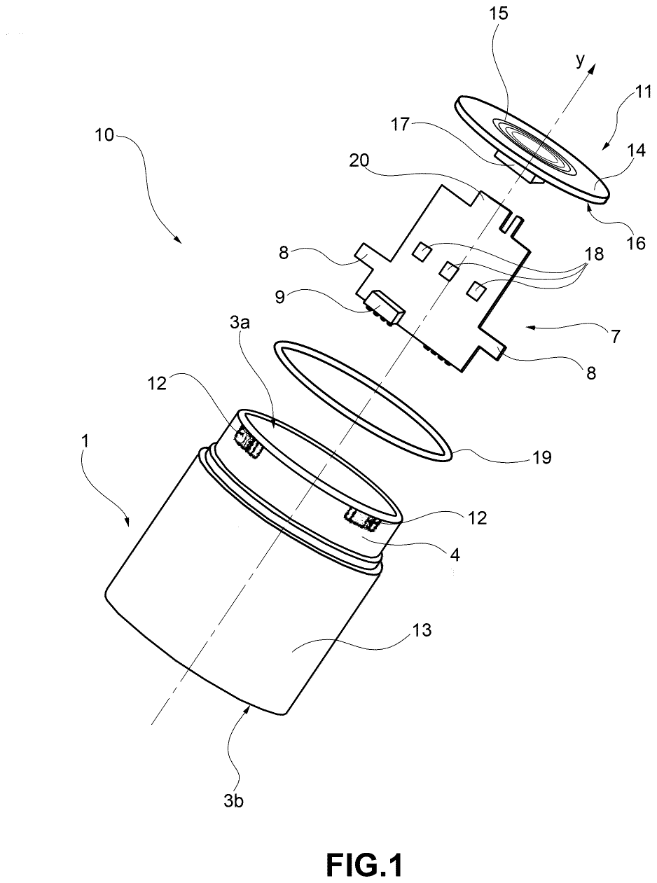

Referring now to FIG. 1, a modular unit 10 according to one form of embodiment of the present invention is shown in exploded view.

According to the form of embodiment described herein, the modular unit 10 is a modular unit comprising a light emitting device 18, modular units comprising acoustic emitting devices or control circuits will be described later.

A modular unit 10 has, in an assembled condition a traditional cylindrical shape elongated along an axial stacking direction Y and is arranged to be mechanically and electrically connected to further modular units 10.

The modular unit 10 comprises an outer element 1 having a side wall 13 in the form of a cylindrical sleeve, an inner surface defining an inner space and a pair of apertures 3a and 3b at opposite axial ends.

The outer element 1 further comprises a connection portion 4 arranged adjacent to a first aperture 3a of the pair of apertures provided with first mechanical bayonet connection means 12.

The outer element 1 is provided with second bayonet mechanical connection means 21 arranged in the inner surface at a second axial end of the outer element 1 and adapted to cooperate with first bayonet mechanical connection means 12 of an axially adjacent modular unit 10.

The modular unit 10 further comprises an electrical connection plate 11 arranged in a removable manner internally to the connection portion 4 and having a first face 14 facing the first aperture 3a, and presenting a plurality of concentrically curved or circular contact tracks 15, and a second face 16 opposite to the first face and presenting at least one electrical connector 17.

According to a preferred embodiment, the electrical connection plate 11 has a circular shape.

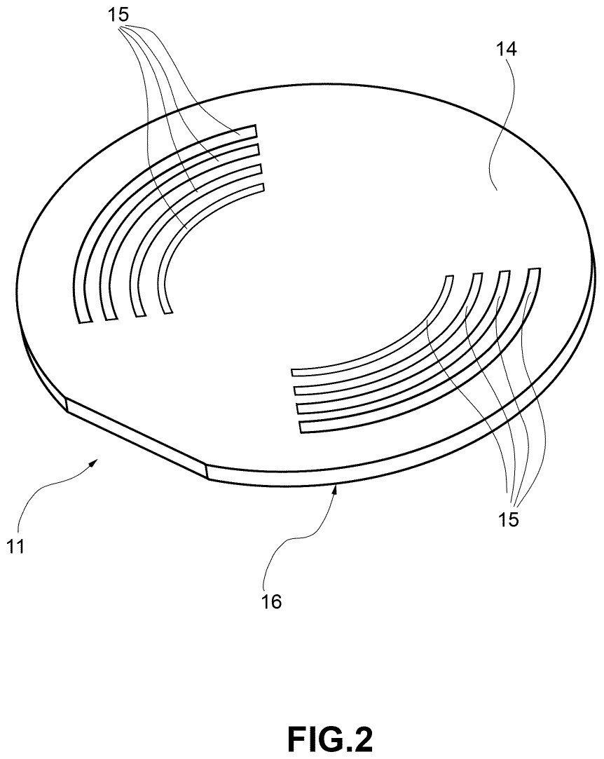

A circular electrical connection plate 11 is shown in a perspective view, presenting the first face 14, in FIG. 2. The angle described by the concentric tracks 15 may, for example, be a function of the geometric dimensions of the first and second mechanical bayonet connection means 12, 21.

Advantageously, the presence of the circular electrical connection plate 11 in modular units for the emission of light signals will limit the emission of light within the outer elements 1 of adjacent modular units 10 by improving the light definition in the use of different light signal colors in different modular units 10 included in a modular column.

The modular unit 10 further comprises a printed circuit board 7 mountable in the inner space of the outer element.

The printed circuit board 7 comprises at least two lateral locking protrusions 8 transversely opposite and apt to cooperate with respective locking slots 6 defined in diametrically opposite positions to the inner surface of the outer element 1, to hold the printed circuit board 7 in a fixed angular position with respect to the outer element 1.

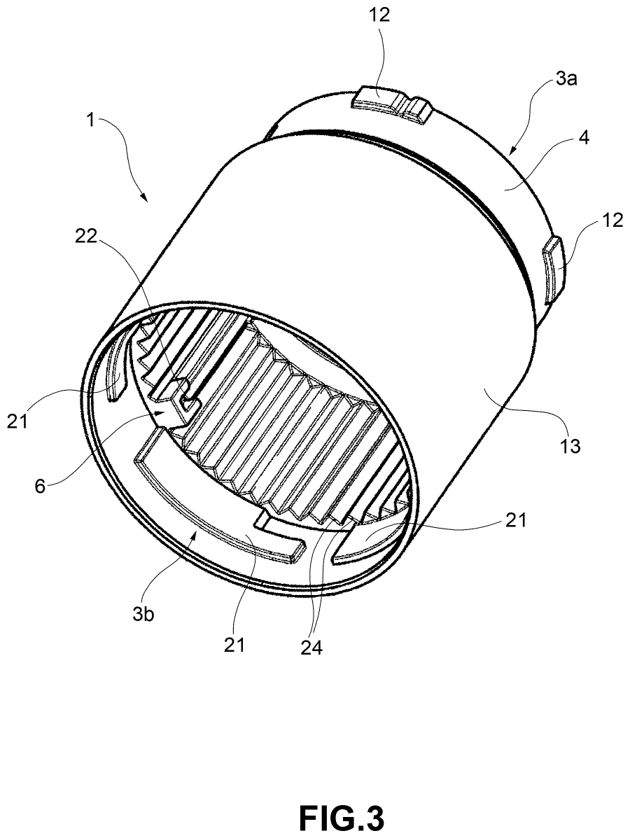

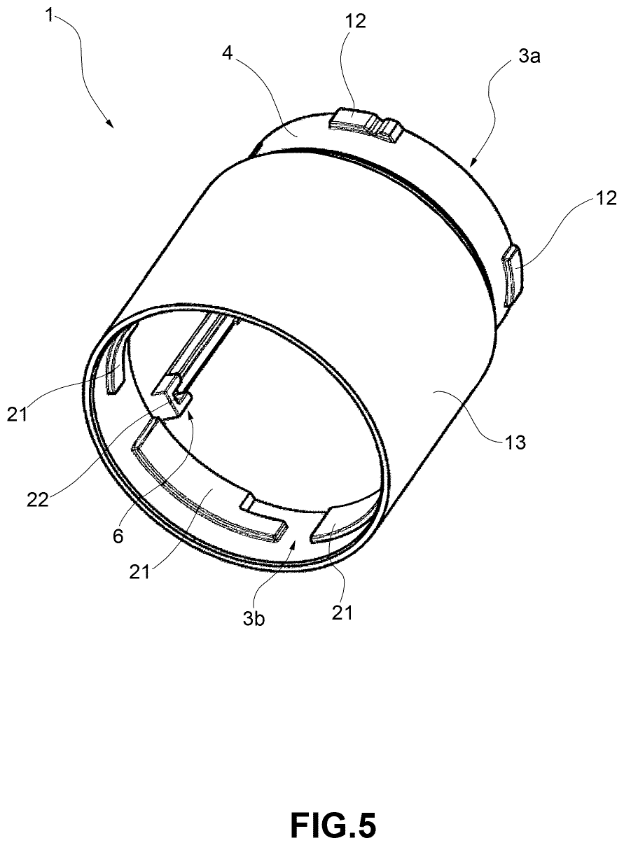

According to an embodiment, each of the locking slots 6 includes a radially protruding relief 22 inwardly from the inner surface shown, for example, in FIGS. 3, 4, 5.

The printed circuit board 7 further includes a first connector 9 protruding axially from a first transverse edge of the printed circuit board 7 to contact by swipe the respective concentric contact tracks 15 of an axially adjacent modular unit 10.

The printed circuit board 7 further comprises, at least one contact terminal 20 disposed on a second transverse edge of the printed circuit board 7 axially opposite the first edge and electrically coupled to the electrical connector of the electrical connection plate 17.

According to this configuration in a condition of a mechanical bayonet coupling between two axially adjacent modular units 10 the modular units 10 are electrically connected by sliding contact between the at least one first connector 9 of one unit 10 and the respective contact tracks of the other unit 10.

Such connection by sliding contact, may be realized, for example, by respective contacting of a plurality of electrical pins present on the at least one first connector 9 with the respective plurality of contact tracks 15.

Such electrical pins may be of different numbers depending on the contact tracks 15 and distributed over several first connectors 9 if more than one is present.

According to a further embodiment, the modular unit further comprises a closed-loop sealing element 19 arranged between the connection portion 4 of one modular unit 10 and the second connection means 21 of the other modular unit 10.

According to a further embodiment of a modular unit for emitting light signals, the printed circuit board 7 comprises at least one light emitting device 18. Said light emitting device 18 may be, not limited to, an LED device. The number is arrangement of light emitting device 18 may vary from that shown in FIG. 1.

According to a further form of embodiment of a modular unit for emitting light signals, the outer element 1 has an at least partly transparent side wall 13 to allow the light signal to be emitted outer to the modular unit 1.

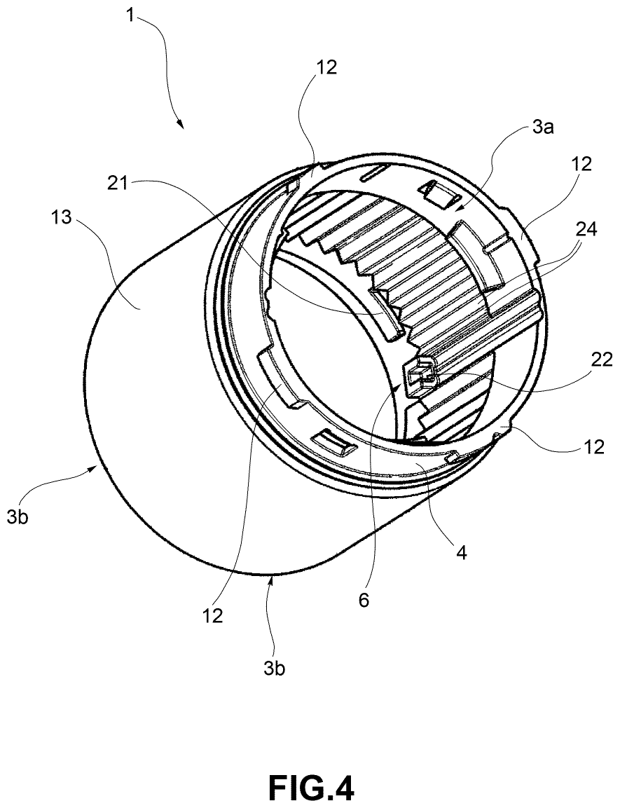

According to a further embodiment of a modular unit for emitting light signals, the outer element 1 comprises optically refractive formations 24 on its inner surface. In FIGS. 3 and 4, two such optically refractive formations 25 are illustrated in an illustrative manner. The optically refractive formations 25 may, for example, have a circular development on the entire inner wall of the outer element 1 or only part or parts of the inner wall.

It is a further object of the present invention to form a modular top column 30 for a modular signaling column comprising a plurality of stackable modular units in a predetermined axial stacking direction Y.

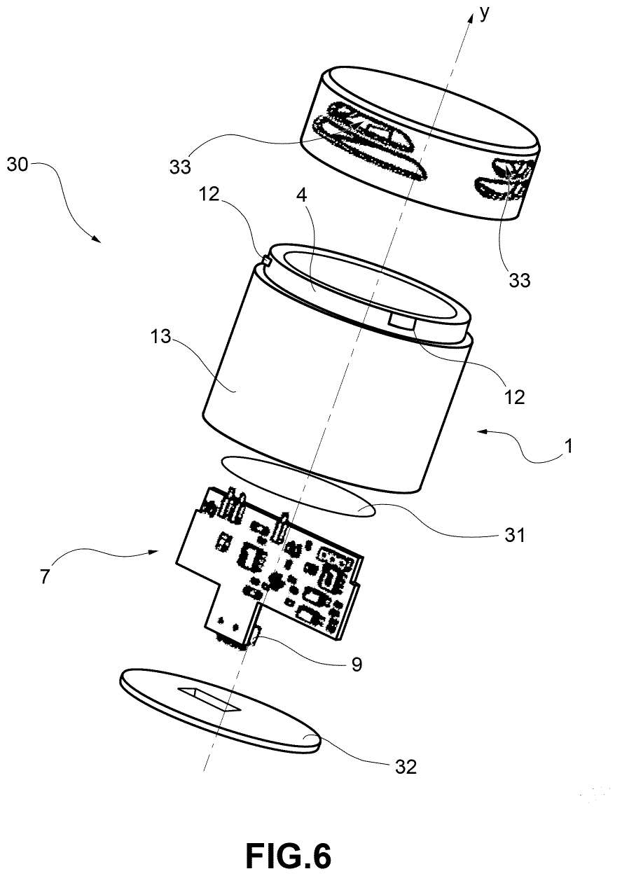

Referring to FIG. 6, one embodiment of a modular top unit 30 according to the present invention is shown.

The modular top unit 30 comprises an outer element 1 having a side wall 13 in the form of a cylindrical sleeve, an inner surface defining an inner space and a pair of apertures 3a and 3b at opposite axial ends.

The outer element 1 comprises second bayonet mechanical connection means 21 arranged in the inner surface at a second axial end of the outer element 1, suitable for cooperating with first bayonet mechanical connection means 12 of an axially adjacent modular unit 10.

The modular top unit 30 further comprises a printed circuit board 7 mountable in the inner space of the outer element 1 configured to be locked in a fixed angular position relative to the outer element 1.

For example, the printed circuit board 7 may be held at a fixed angular position by a mounting plate 32 having an opening arranged to accommodate a protrusion from a first transverse edge of the printed circuit board 7 and hold the printed circuit board 7 at a fixed angular position relative to the outer element 1 when integral therewith.

The modular top unit 30 further comprises a device for emitting acoustic signals 31 associated with and controlled by the printed circuit board 7.

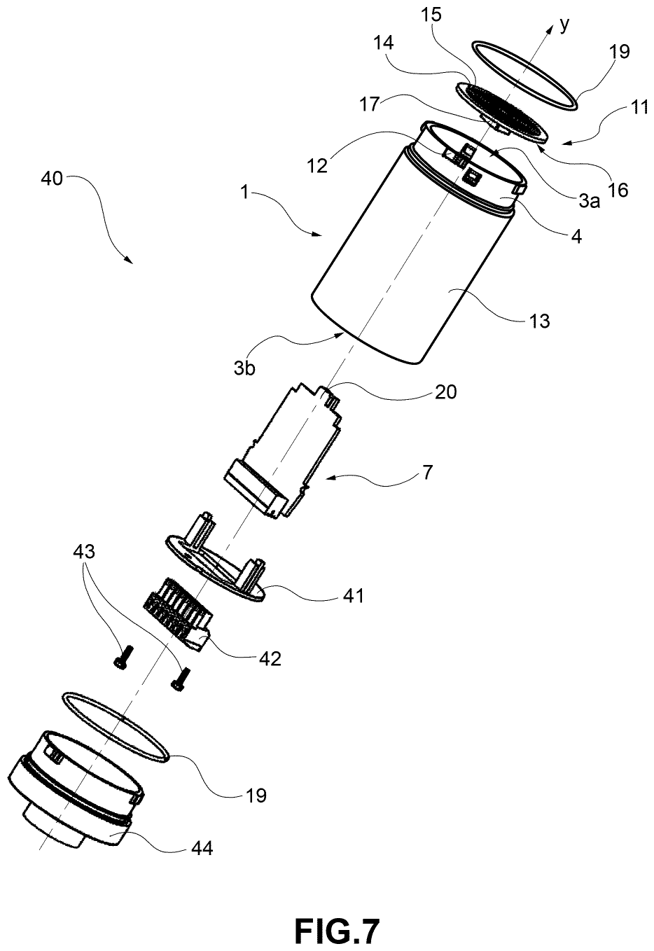

A piezoelectric type acoustic signal emitting device 31 is shown in FIG. 7. This type of device is not to be considered as limiting.

The printed circuit board 7 further comprises a first connector 9 protruding axially from the first transverse edge of the printed circuit board 7 and contacting the respective concentric contact tracks 15 of an axially adjacent modular unit 10.

According to such a configuration in a condition of mechanical bayonet coupling between the top unit 30 and an axially adjacent modular unit 10, the top modular unit 30 and the modular unit 10 are electrically connected by sliding contact between the first connector 9 of the top unit 30 and the respective contact tracks of the modular unit 10.

According to a further embodiment of a modular top unit 30 for the emission of acoustic signals, the outer element 1 has openings 33 in the side wall 33 for the outward diffusion of the acoustic signal generated by an acoustic emitter device.

In FIG. 6, the apertures 33 are shown on an element that can be associated by means of a mechanical connection to the outer element 1. The apertures 33 may, in a further configuration, be present on the wall of the outer element 1.

It is a further object of the present invention to provide a modular control unit 40, for a modular signaling column comprising a plurality of modular units stackable in an axial stacking direction Y.

Referring now to FIG. 7, an exploded perspective view of components of a modular control unit 40 according to an embodiment of the present invention is shown.

The modular unit 40 includes an outer element 1 having a side wall 13 in the shape of a cylindrical sleeve with an inner surface defining an inner space, a pair of apertures 3a, 3b at opposite axial ends a connection portion 4 arranged adjacent to a first opening 3a and provided with first bayonet mechanical connection means 12 capable of cooperating with second bayonet mechanical connection means 21 of an axially adjacent modular unit 10 or with second bayonet mechanical connection means 21 of a top modular unit.

The modular unit further includes an electrical connection plate 11 removably arranged internally to the connection portion 4 and having a first face 14 facing the first aperture 3a, and presenting a plurality of concentrically curved or circular contact tracks 15, and a second face 16 opposite the first face and presenting at least one electrical connector 17.

A printed circuit board 7 configured to be locked in a fixed angular position with respect to the outer element 1 is mountable within the inner space of the outer element 1.

For example, the printed circuit board 7 may be held in a fixed angular position by a printed circuit board holder 41 arranged to hold the printed circuit board 7 in a fixed angular position when integral with the outer element 1.

The printed circuit board 7 comprises at least one control circuit of the modular signaling column.

The control circuit may be arranged to control the operating parameters of light emitting devices 18 and/or acoustic emitting devices of modular units associated with the modular signaling column in which there is, for example, a function of signals received from a machinery associated with the modular column. The printed circuit board 7 further comprises at least one contact terminal 20 arranged on a second transverse edge of the printed circuit board 7 axially opposite the first edge and electrically coupled to the at least one electrical connector 17 of the electrical connection plate 11.

According to this configuration in a condition of mechanical bayonet coupling between the control unit 40 and an axially adjacent modular unit 10, the modular control unit 40 and the modular unit 10 are electrically connected by sliding contact between the at least one first connector 9 of the modular unit 10 and the respective contact tracks 15 of the control unit 40.

Further forming an object of the present invention is a modular column comprising a modular control unit 40 and at least one modular top unit 30 and/or a modular unit 10.

Various aspects and forms of embodiments of modular signaling column units have been described. It is understood that each form of embodiment may be combined with any other form of embodiment. Furthermore, the invention is not limited to the described forms of embodiment, but may be varied within the scope defined by the appended claims.

What is claimed is

1. A modular unit for a modular signaling column comprising a plurality of modular units stackable in a predetermined axial stacking direction, said modular unit comprising:
an outer element comprising a side wall in a form of a cylindrical sleeve with an inner surface defining an inner space, a pair of apertures at opposite axial ends, a connection portion arranged adjacent to a first aperture of said pair of apertures and provided with a first bayonet mechanical connection means and a second bayonet mechanical connection means arranged in the inner surface at a second axial end of the outer element, capable of co-operating with a first bayonet mechanical connection means of an axially adjacent modular unit;
an electric connection plate arranged in a removable manner internally to the connection portion and having a first face facing said first aperture, and presenting a plurality of arcuate or circular concentric contact tracks, and a second face, opposite the first face and presenting at least an electric connector; and
a printed circuit board mountable in the inner space of the outer element and comprising:
locking means of the printed circuit board with respect to said outer element, in order to keep the printed circuit board at a fixed angle to the outer element;
at least one first connector protruding axially from a first transverse edge of the printed circuit board and capable of contacting respective concentric contact tracks of an axially adjacent modular unit by sliding contact; and
at least one contact terminal arranged on a second transverse edge of the printed circuit board axially opposite the first edge and electrically coupled to at least said electrical connector of the electrical connection plate; whereby
in a condition of mechanical bayonet coupling between two axially adjacent modular units said two axially adjacent modular units are electrically connected by sliding contact between said at least one first connector of one of the two axially adjacent modular units and the respective contact tracks of the other one of the two axially adjacent modular units.

2. The modular unit of claim 1, wherein said locking means includes a radially protruding depression inwardly from the inner surface.

3. The modular unit of claim 1, wherein said electrical connection plate has a circular shape.

4. The modular unit of claim 1, wherein said printed circuit board further comprises at least one light emitting device.

5. The modular unit of claim 1, wherein said outer element comprises an at least partly transparent side wall.

6. The modular unit of claim 5, wherein said outer element comprises optically refractive formations on its inner surface.

7. A modular top unit for a modular signaling column comprising a plurality of modular units stackable in a predetermined axial stacking direction, said modular top unit comprising:
an outer element comprising a side wall in a form of a cylindrical sleeve with an inner surface defining an inner space, a pair of apertures at opposite axial ends, second mechanical bayonet connection means arranged in the inner surface at a second axial end of the outer element capable of cooperating with first mechanical bayonet connection means of an axially adjacent modular unit according to claim 1;
a printed circuit board mountable in the inner space of the outer element configured to be locked in a fixed angular position with respect to the outer element; and
an acoustic signal output device associated with and controlled by said printed circuit board;
wherein said printed circuit board comprises at least one first connector protruding axially from a first transverse edge of said printed circuit board and capable of contacting respective concentric contact tracks of an axially adjacent modular unit according to claim 1; and wherein
in a condition of mechanical bayonet coupling between the modular top unit and an axially adjacent modular unit according to claim 1, the top modular unit and said axially adjacent modular unit are electrically connected by sliding contact between said at least one first connector of the modular top unit and the respective contact tracks of said axially adjacent modular unit.

8. The modular top unit of claim 7, wherein said outer element has openings in said side wall.

9. A modular control unit, for a modular signaling column comprising a plurality of modular units stackable in a predetermined axial stacking direction, said modular control unit comprising:
an outer element comprising a side wall in a form of a cylindrical sleeve with an inner surface defining an inner space, a pair of apertures at opposite axial ends, a connection portion arranged adjacent to a first aperture of said pair of apertures and provided with first mechanical bayonet connection means capable of cooperating with second mechanical bayonet connection means of an axially adjacent modular unit according to claim 1 or with second mechanical bayonet connection means of a top modular unit for the modular signaling column comprising the plurality of modular units stackable in the predetermined axial stacking direction, said modular top unit comprising:
an outer element comprising a side wall in a form of a cylindrical sleeve with an inner surface defining an inner space, a pair of apertures at opposite axial ends, second mechanical bayonet connection means arranged in the inner surface at a second axial end of the outer element capable of cooperating with first mechanical bayonet connection means of an axially adjacent modular unit according to claim 1;
a printed circuit board mountable in the inner space of the outer element configured to be locked in a fixed angular position with respect to the outer element; and
an acoustic signal output device associated with and controlled by said printed circuit board;
wherein said printed circuit board comprises at least one first connector protruding axially from a first transverse edge of said printed circuit board and capable of contacting respective concentric contact tracks of an axially adjacent modular unit according to claim 1; and wherein
in a condition of mechanical bayonet coupling between the modular top unit and an axially adjacent modular unit according to claim 1, the top modular unit and said axially adjacent modular unit are electrically connected by sliding contact between said at least one first connector of the modular top unit and the respective contact tracks of said axially adjacent modular unit;
an electrical connection plate arranged in a removable manner internally to the connection portion and having a first face facing said first aperture, and presenting a plurality of arcuate or circular concentric contact tracks, and a second face, opposite the first face and presenting at least one electrical connector; and
a printed circuit board mountable in the inner space of the outer element configured to be locked at a fixed angle to the outer element and comprising
at least one modular signaling column control circuit; and
at least one contact terminal arranged on a second transverse edge of the printed circuit board axially opposite the first edge and electrically coupled to at least said electrical connector of the electrical connection plate; whereby
in a condition of mechanical bayonet coupling between the modular control unit and an axially adjacent modular unit according to claim 1, the modular control unit and the axially adjacent modular unit are electrically connected by sliding contact between said at least one first connector of the modular unit and the respective contact tracks of said modular control unit.

10. A modular signaling column comprising:
a modular control unit for a modular signaling column comprising a plurality of modular units stackable in a predetermined axial stacking direction, said modular control unit comprising:
an outer element comprising a side wall in a form of a cylindrical sleeve with an inner surface defining an inner space, a pair of apertures at opposite axial ends, a connection portion arranged adjacent to a first aperture of said pair of apertures and provided with first mechanical bayonet connection means capable of cooperating with second mechanical bayonet connection means of an axially adjacent modular unit according to claim 1 or with second mechanical bayonet connection means of a top modular unit for the modular signaling column comprising the plurality of modular units stackable in the predetermined axial stacking direction, said modular top unit comprising:
an outer element comprising a side wall in a form of a cylindrical sleeve with an inner surface defining an inner space, a pair of apertures at opposite axial ends, second mechanical bayonet connection means arranged in the inner surface at a second axial end of the outer element capable of cooperating with first mechanical bayonet connection means of an axially adjacent modular unit according to claim 1;
a printed circuit board mountable in the inner space of the outer element configured to be locked in a fixed angular position with respect to the outer element; and
an acoustic signal output device associated with and controlled by said printed circuit board;
wherein said printed circuit board comprises at least one first connector protruding axially from a first transverse edge of said printed circuit board and capable of contacting respective concentric contact tracks of an axially adjacent modular unit according to claim 1; and wherein
in a condition of mechanical bayonet coupling between the modular top unit and an axially adjacent modular unit according to claim 1, the top modular unit and said axially adjacent modular unit are electrically connected by sliding contact between said at least one first connector of the modular top unit and the respective contact tracks of said axially adjacent modular unit;
an electrical connection plate arranged in a removable manner internally to the connection portion and having a first face facing said first aperture, and presenting a plurality of arcuate or circular concentric contact tracks, and a second face, opposite the first face and presenting at least one electrical connector; and
a printed circuit board mountable in the inner space of the outer element configured to be locked at a fixed angle to the outer element and comprising
at least one modular signaling column control circuit; and
at least one contact terminal arranged on a second transverse edge of the printed circuit board axially opposite the first edge and electrically coupled to at least said electrical connector of the electrical connection plate; whereby
in a condition of mechanical bayonet coupling between the modular control unit and an axially adjacent modular unit according to claim 1, the modular control unit and the axially adjacent modular unit are electrically connected by sliding contact between said at least one first connector of the modular unit and the respective contact tracks of said modular control unit, and
at least one modular unit according to claim 1 and/or the modular top unit.
